(19) United States
(12) Patent Application Publication
(10) Pub. No.: US 2006/0165032 A1
(43) Pub. Date: Jul. 27, 2006

(54) Method of reducing interference in indoor cell in wireless cellular communication network

(76) Inventors: Jyri Hamalainen, Oulu (FI); Esa Tiirola, Oulu (FI); Ilkka Keskitalo, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/095,654

(22) Filed: Apr. 1, 2005

(30) Foreign Application Priority Data
Jan. 25, 2005 (FI) 20055032

(51) Int. Cl. H04Q 7/00

(52) U.S. Cl. 370/328

(57) ABSTRACT

The invention relates to reducing interference in indoor cells in a wireless cellular communication network. Outdoor and indoor base stations operate at a common uplink carrier frequency. The indoor base station monitors an uplink inter-cell interference level, and, responsive to the uplink inter-cell interference level reaching a predetermined threshold level, synchronizes with an uplink transmission signal received from at least one potentially interfering user equipment which is connected to the outdoor base station but outside the downlink coverage area of the indoor base station. The interfering user equipment is commanded, via a downlink control channel of the outdoor base station, to lower the transmission power of the uplink transmission signal, and to thereby decrease the uplink inter-cell interference level on indoor base station.

### FIELD OF THE INVENTION

The present invention relates to wireless cellular communication networks.

### BACKGROUND OF THE INVENTION

Mobile wireless communication systems are typically based on a cellular architecture that makes it possible to reuse radio frequencies. Traditional cellular systems, such as the GSM, are designed so that adjacent cells use different frequencies. As long as the cells are separated and the signal strength calibrated, there will not be harmful inter-cell interference. Third-generation (3G) and 3.5G mobile communication networks are mainly spread-spectrum systems, i.e. they employ the code division multiple access (CDMA) technology, often in combination with the time division multiple access (TDMA) and/or the frequency division multiple access (FDMA) technologies. In contrast to TDMA and FDMA, multiple subscribers can use the same frequency band at the same time in the CDMA systems. The Universal Mobile Telecommunication System (UMTS) specified by the Third Generation Partnership Project (3GPP) employs wideband CDMA which is a wideband direct-sequence code-division multiple-access (DS-CDMA) system. Digital, binary subscriber information is linked in a transmitter with a spreading code generated by a code generator. This process is termed a spreading. The spreading code consists of a high chip-rate code sequence. Each code channel has its own code, and all users are distinguished from each other by using orthogonal spreading codes. The information obtained by the spreading is modulated to a carrier frequency. The broadband signal is transmitted over the radio interface. The receiver demodulates the signal and links the resulting information with the same spreading code used in the transmitter. This process is known as despreading which restores the original subscriber information. By assigning to all users different spreading codes having a very small—theoretically zero—cross-correlation, it is possible to despread the signal at the receiver and retrieve the original data signal for each user even when very low transmitter powers are used. This results in a much more efficient use of the available frequency resources. Neighboring cells can use same frequencies, i.e. the frequency re-use factor can become equal to 1.

During the architecture design of the UMTS system, attention was paid to the diversity of the user environment. Indoor, outdoor urban and outdoor rural environments are supported in addition to different mobility models ranging from stationary users through the pedestrian up to very high vehicular speeds. To offer worldwide coverage and enable global roaming, a hierarchical-layer structure of four different zones with varying coverage was developed for UMTS. The three lower layers form the terrestrial radio access network, UTRAN, while the highest layer consists of satellites covering the whole planet. In the UTRAN, each layer is built up of cells; the lower the layer, the smaller the geographical area covered by the cell. Therefore, small cells have been implemented to support higher user density. Macrocells are used for servicing suburban and rural areas with a medium-range population density. The cell radius of the macrocells ranges from hundreds of meters to several kilometers. Microcells are used for servicing areas called hot spots. These are inner-city areas, public places, sports stadiums, indoor environments, and the like. The service radius of the microcells ranges from dozens of meters to several hundred meters, i.e., relatively small areas with high user densities and little or medium mobility are supported. Picocells are used for servicing indoor office environments, such as large offices, domestic households, department stores, and the like. The service radius of the picocells is in the order of several dozens of meters, i.e. small areas with high user densities and little mobility are supported. It should be noted that the cell sizes are only examples.

In CDMA systems, since many subscribers transmit on the same frequency band and as the same frequency can be used in principle in each cell (radius=1), each user can cause interference to the others. The capacity of the CDMA system is mainly limited by the (inter-cell and intra-cell) interference level. Therefore, effective power control is used to limit interferences and to optimize the system capacity.

In a CDMA system, there may be a problem related to the uplink interference between the outdoor and indoor cells. FIG. 1 illustrates this problem. It is assumed that base stations BTS 100, 101 and 104 operate on the same frequency band. Base stations 101 and 104 are designed and configured for indoor purposes. The downlink transmission powers of the BTSs 101 and 104 are relatively low when compared with the transmission power of the outdoor BTS 100. According to the present WCDMA specifications, the user equipment UE selects an active set of cells based on a received signal-to-interference ratio (SIR) of a common pilot channel (CPICH). The active set of cells refers to the group of cells with which the UE has a connection. As is well known in the art, while the UE normally communicates with one base station at a time, the UE can communicate with two or more base stations during a soft handover due to the fact that all cells use the same frequency; for example in the situation where a mobile station enters a boundary area between two or three cells. During a soft handover, each of the base stations in the active set of cells receive the transmission from the UE, despreads it and forwards the information to the controlling network element, such as the radio network controller (RNC). The RNC combines this information and forwards it to the core network (CN), for example. This procedure is implemented frame by frame. The quality of detection is the basis for the assessment. Only information in top-quality frames is used. The gain due to reception of additional signals in soft handovers is also known as macro-diversity.

In the example illustrated in FIG. 1, the outdoor UE 102 is not noticing the indoor base stations 101 and 104, since the transmission power of these base stations is low and the building walls 500 and 501 attenuate the downlink signal coverage 201 and 202 of the base stations 101 and 104, respectively. In consequence, the outdoor UE 102 sets up a connection with the outdoor BTS 100 only. However, the uplink transmission power of the outdoor UE 102 needs to be high in order to maintain the required uplink coverage 401. As a result, the outdoor UE 102 generates a high interference level at the indoor BTSs 101 and 104, thereby causing an increase in the transmission powers of the indoor user equipment UE 103 having a connection with the indoor BTS 101. This phenomena result in an increasing inter-cell interference in the uplink direction, which is crucial for the system capacity.

The interference scenarios for the example of FIG. 1 are further illustrated in FIG. 2. We can identify four separate interference scenarios. The first case is an interference 200 from the outdoor base station BTS 100 to the indoor UE 103. The interference 200 is not a significant problem, since the walls of the building attenuate the downlink signal from the outdoor BTS 100, and the transmission power level of the indoor BTS 101 is designed so that G values within the building are suitable. In the second scenario, the interference 201 is generated from the indoor BTS 101 to the outdoor UE 102. The interference 201 should not be a significant problem, since in this case, too, the building walls attenuate the downlink signal from the indoor BTS 101. Moreover, if the outdoor UE 102 can well detect the signal from the indoor BTS 101, a soft handover can be employed. In the third scenario, the interference 300 is generated from the outdoor UE 102 to the indoor BTS 101. This is the main problem overcome by the present invention. If the outdoor UE 102 does not detect the common pilot signal from the indoor BTS 101 (as the building walls attenuate the signal) and, therefore, a soft handover cannot be used, the uplink transmission of the outdoor UE 102 can generate a high inter-cell interference level on the indoor BTS 101. Moreover, the outdoor UE 102 follows the power control commands of the outdoor BTS 102, which may result in a very high instantaneous interference level for indoor BTS 101. In the fourth scenario, the interference 301 is generated from the indoor UE 103 to the outdoor BTS 100. The interference 301 is negligible provided that there is no inter-cell interference. If the interference 300 is present, the power competition between the outdoor UE 102 and the indoor UE 101 may also result in an increased interference level at the outdoor BTS 100.

As noted above, the prior art solution to the interference problem is a soft handover (SHO) where the user equipment UE is connected with two or more base stations simultaneously. Let us assume that the outdoor UE 102 shown in FIG. 1 is applying the soft handover. In that case, the outdoor UE 102 receives power control commands from both the outdoor BTS 100 and the indoor BTS(s) 101 and/or 104, and lowers the uplink transmission power if any one of the connected base stations 100, 101, or 102 sends a power-down command.

This solves the problems relating to the interferences 300 and 301. However, if the outdoor UE cannot detect the common pilot signal from the indoor base stations 101 and 104, the outdoor UE can be connected only to the outdoor base station 100 according to the present specifications, and the problem remains unsolved.

One possibility to solve the problem would be to increase the transmission power of the common pilot channel for the indoor base stations. Consequently, this would enable a soft handover of the interfering outdoor UEs between the indoor and outdoor base stations, since the outdoor UEs now can detect the common pilot signal from the indoor base stations. However, this approach would waste the power and code resources of the indoor base stations by allowing the outdoor UEs use the limited downlink resources of the indoor base stations. At the same time the interference problems in the downlink direction would increase for both the indoor and outdoor UEs.

### DISCLOSURE OF THE INVENTION

An object of the invention is to decrease inter-cell interference caused by an uplink transmission.

This object of the present invention is achieved with a wireless cellular communication network, a microcell base station, and a controlling network element according to the attached independent claims. Preferred embodiments of the invention are defined in the dependent claims.

In an embodiment of the present invention, a small-coverage base station having a smaller downlink coverage area (cell) is arranged to synchronize with potentially interfering user equipment which is connected to at least one other base station having a larger downlink coverage area (cell) but which is outside the downlink coverage area of the small-coverage base station. This resembles a situation where user equipment carries out a soft handover via a large-coverage base station and a small-coverage base station while being located within a downlink coverage area of the small-coverage base station, but in the process according to the present invention, the user equipment is outside area of the small-coverage base station and no downlink connection is provided between the user equipment and the small-coverage base station. Then, after having synchronized the small-coverage base station to receive the interfering uplink signal, an appropriate controlling entity in the cellular communication network controls, via the downlink control channel of the large-coverage base station having the downlink connection, the interfering user equipment to lower the transmission power of the uplink transmission signal and to thereby decrease the uplink inter-cell interference level experienced by the small-coverage base station.

In an embodiment of the invention, the ratio between the transmission power of a dedicated uplink control channel and the transmission power of a dedicated uplink data channel of an interfering user equipment is adjusted. The ratio may be adjusted so that the transmission power of a dedicated uplink data channel becomes lower and the difference between the transmission powers of the uplink control channel and the uplink data channel of the user equipment becomes smaller. The benefit of this arrangement is that the control channel connection to the large-coverage base station is not jeopardized by the power control according to the invention, while at the same time the interference level at the small-coverage base station becomes lower since the data channel is the dominant interference source in the uplink direction. The loss of quality of the uplink data channel at the large-coverage base station may be compensated by employing macro-diversity combining on the uplink data signals received via the large-coverage base station and the small-coverage base station from the user equipment. It is apparent that the macro-diversity combining gain will improve data detection, since the uplink signal level received at the microbase station is high, otherwise the user equipment would not be a dominant interferer to the small-coverage base station.

The large-coverage base station may be an outdoor base station and the small-coverage base station may be an indoor base station. The present invention makes it possible to reduce an uplink interference from outdoor user equipment to an indoor base station and, at the same time, to increase the capacity of an outdoor base station to which the interfering outdoor user equipment is connected, since the intra-cell interference decreases while the transmission power of the outdoor user equipment decreases.

### BRIEF DESCRIPTION OF THE DRAWINGS

Examples of embodiments of the present invention will now be illustrated in more detail with reference to the attached drawings, in which

FIG. 1 is a schematic presentation illustrating an example of a wireless cellular communication network including indoor and outdoor base stations;

FIG. 2 is a schematic presentation illustrating various interferences present in the wireless cellular communication network of FIG. 1;

FIG. 3 is a block diagram illustrating an example of the architecture of a WCDMA system:

FIG. 4 is a block diagram illustrating examples of the structures of the radio network controller and the base station of FIG. 3:

FIG. 5 is a flow diagram illustrating an example embodiment for carrying out the uplink soft handover and the uplink interference power control according to the present invention; and

FIG. 6 is a flow diagram illustrating how the uplink interference power control may detect and react to sudden changes in the level of the interfering uplink signal.

### DETAILED DESCRIPTION OF EXAMPLES

The present invention may be applied to any wireless cellular communication network which includes base stations with downlink coverage areas of different sizes so that an uplink transmission signal of user equipment communicating with a base station with a larger downlink coverage area may cause interference to a base station with a smaller downlink coverage area, when the base stations are operating at the one and same uplink carrier frequency. Multiplex methods are used to divide the limited frequency resources of a cell and a cellular network between the different subscribers and mobile stations. Three different methods are mainly used today: frequency division multiple access (FDMA), time division multiple access (TDMA), and code division multiple access (CDMA). The present invention can be applied together with any of these different multiple access methods, or to systems utilizing combinations of different multiple access methods. The present invention is especially applicable to a CDMA system where multiple subscribers can use the same frequency band at the same time. The following examples illustrate the use of the invention in third-generation (3G) systems, such as UMTS, or higher-generation mobile communication systems (3.5G, 4G, . . . ) employing a wideband code division multiple access method (WCDMA) implemented with a direct-sequence technique, without restricting the invention thereto, however.

A structure of a 3G mobile communication system will be described by way of an example with reference to FIG. 3. The main components of a 3G mobile communication system include a core network CN, an UMTS terrestrial radio access network UTRAN, and user equipment UE. The interface between the CN and the UTRAN is referred to as an lu interface, the air interface between the UTRAN and the UE is referred to as an Uu interface, and the interface between a radio network controller RNC and a base station B is called an lub interface.

The user equipment UE may comprise two parts: a mobile equipment ME that comprises a radio terminal used for setting up a radio connection over the Uu interface, and a UMTS subscriber identity module USIM that is a smart card containing data related to user identity and typically carries out authentication algorithms and stores encryption parameters and subscriber data.

The core network CN may comprise any communication network or service utilizing the wireless access services of the UTRAN. As an example, a GPRS (general packet radio service) core network is shown in FIG. 3. As is well known to a person skilled in the art, a GPRS core network may include a home location register HLR and visitor home register VLR for subscriber data and mobility management, a mobile services switching centre MSC and a gateway MSC (GMC) for providing circuit-switched connections, and GPRS support nodes SGSN and gateway support nodes GGSN for providing packet-switched connections and the related mobility management. Via the GMSC and the GGSN the core network may be connected to external networks which are typically of two types: circuit-switched networks, such as existing telephone networks (PLMN, PSTN, ISDN), and packet-switched networks, such as the Internet.

The UTRAN comprises radio network subsystems RNS, each of which may include a radio network controller RNC and a plurality of nodes B. In the UTRAN several nodes B may be controlled in a centralized manner by an RNC communicating with them. Node B is in practice a base station, and the RNC controls radio resources of base stations connected thereto.

The block diagram shown in FIG. 4 illustrates an example of a radio network subsystem RNS. FIG. 4 shows the structure on a rather general level, illustrating only the blocks useful for describing the present invention, but it is evident to a person skilled in the art that a cellular radio network also includes a number of other functions and structures which need not be described in more detailed herein.

In FIG. 4, base station 404 comprises transceivers 408, a multiplexer unit 412, and a control unit 410 which controls the operation of the transceivers 408 and the multiplexer 412. The multiplexer 412 is used to switch the traffic and control channels used by several transceivers 408 to a common transmission link 414. The transmission link 414 forms the lub interface.

The transceivers 408 of the base station 404 are connected to an antenna unit 418, which implements a bidirectional radio connection 416 to the user equipment 402. The structure of the frames to be transmitted over the bi-directional radio connection 416 is specified in each system, and it is referred to as an air interface Uu.

An example of a radio network controller RNC is also illustrated in FIG. 4. In the example of FIG. 4, the radio network controller 406 comprises a group-switching field 420 and a control unit 422. The control unit 422 performs call control, mobility management, signaling and gathers statsistical data. In an embodiment of the invention, the control unit 422 also performs macro-diversity combining during a soft handover.

The air interface Uu will be examined below using the WCDMA signal as an example without restricting the invention to the specific air interface or to the WCDMA. The scrambling and channelization coding used in the UMTS will be examined below in an example of coding a WCDMA signal. A signal to be transmitted from the transmitter is first multiplied by a channelization code and then by a scrambling code. The scrambling code is used to distinguish from one another the terminal equipment on one hand and the base stations on the other hand. The channelization code enables distinguishing between signals transmitted from the same transmitter.

Radio systems typically comprise two types of transmission channels, i.e. dedicated channels and common channels. A common channel is intended for all users or a group of users in a particular cell. Dedicated channels in turn are intended for only one user. A dedicated channel is identified by means of the frequency and the scrambling code used.

Pilot signals may be used in a base station transmission in CDMA systems. There may be various types of pilot signals. Firstly, there may be common pilots, which are intended for all the terminal equipment collectively. Secondly, there may be dedicated pilots, which are included in the transmission of one user signal. Common pilot signals are used in the terminal equipment for forming a channel estimate for a dedicated channel. Similarly, several other measurements are also carried out on a common pilot signal, such as handover, synchronization and idle mode cell selection measurements. If terminal equipment does not have a dedicated channel, the channel estimate is normally formed based on the common pilot. RNC can command the terminal equipment to use dedicated pilots for channel estimation. This may happen for instance in case of user specific beamforming. However, dedicated pilots are there for SIR estimation purposes primarily. The common pilot is typically transmitted with such a radiation pattern in the cell that ensures that the pilot can be received by all the terminal equipment in the cell. A common pilot is typically transmitted at a power level that constitutes a significant proportion (e.g. 10%) of the entire base station transmit power. A common pilot is transmitted by means of a particular channelization code and a scrambling code.

We will examine below in more detail and by way of example the pilot signals used in the UMTS. In the UMTS, the common pilot channel (CPICH) is an unmodulated code signal multiplied by a cell-specific scrambling code. The CPICH has a fixed data rate and spreading factor. The purpose of the signal is to assist the terminal equipment in the channel estimation of the dedicated channel and to provide the common channels with a channel estimation reference. A dedicated pilot contained in the transmission of one user signal is also transmitted in the UMTS. A dedicated pilot is transmitted in both transmission directions. Dedicated pilot symbols can be used for channel estimation. For example, a downlink frame may be 10 ms in length and include 15 time slots. Each time slot may comprise several fields, such as DATA (for transmission of actual information), TPC (symbols for the Transmit Power Control), TFCI (information on the transfer rate used in the time slot) and PILOT (pilot signal symbols).

In the uplink direction, when there is a dedicated, active connection, the user equipment UE transmits a control information signal on a DPCCH channel (Dedicated Physical Control Channel), and user traffic on a DPDCH (Dedicated Physical Data Channel). In the uplink direction, the DPCCH and DPCCH are separated by I/Q (In-phase/Quadrature) modulation. The DPCCH channel includes a time-multiplexed pilot signal, which is used at the base station receiver for example in channel estimation, SIR estimation (Signal-to-Interference Ratio), direction-of-arrival estimation. The signal-to-interference ratio obtained for the channel can be used to control the power control of a closed loop, for instance.

It is vital to have power control of signals in a radio system. This is of particular importance in a CDMA radio system, which is interference-limited. The main task of the power control in a CDMA radio system is to set signal powers to the desired level, and hence increase capacity by decreasing interference.

For example, in a WCDMA radio system the power control mechanism comprises an inner-loop power control and an outer-loop power control. The purpose of the inner-loop power control is to eliminate rapid variations in the strength of a received signal caused by the radio channel and propagation. In the uplink inner-loop power control, a base station compares the measured SIR (Signal Interference Ratio) of the received signal with a target SIR. If the measured SIR of the received signal is below the target SIR, the base station transmits a signal commanding the user terminal to increase its transmission power. Correspondingly, if the SIR of the received signal is above the target SIR, the base station transmits a signal commanding the user terminal to decrease its transmission power. In the uplink outer-loop control, a radio network controller RNC compares the quality of service to a target quality. The quality can be measured as BER (Bit Error Rate), BLER (Block Error Rate), FER (Frame Error Rate), CRC (Cyclic Redundancy Check), soft information from the decoder, ratio of received bit energy and noise, or the like. If the quality of service is below the target quality, the RNC commands the base station to increase its target SIR. Similarly, if the quality of service is above the target quality, the RNC commands the base station to decrease its target SIR.

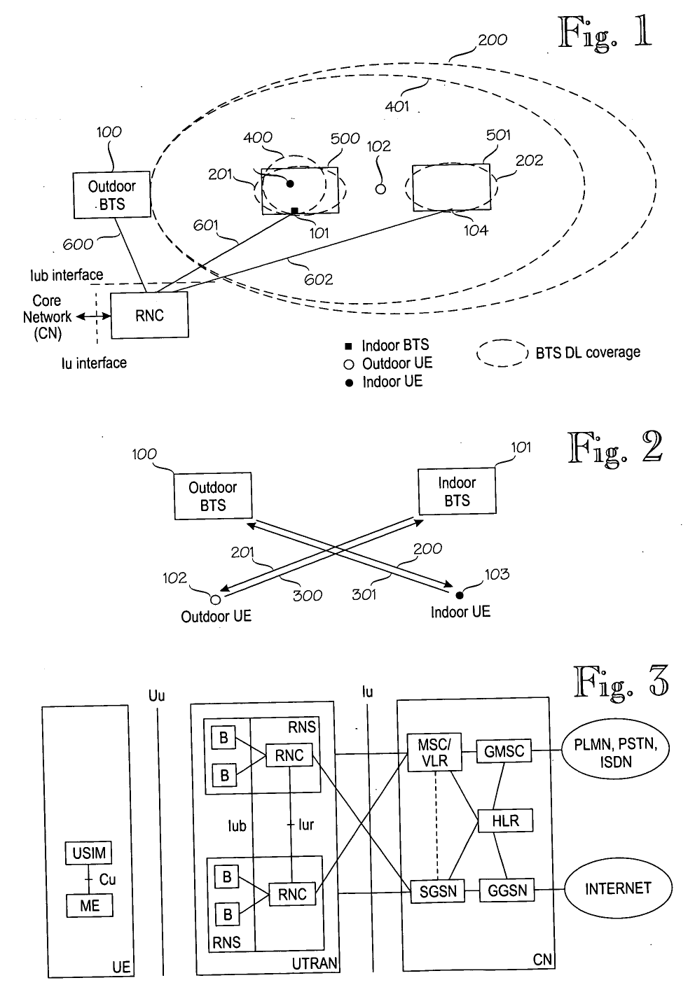

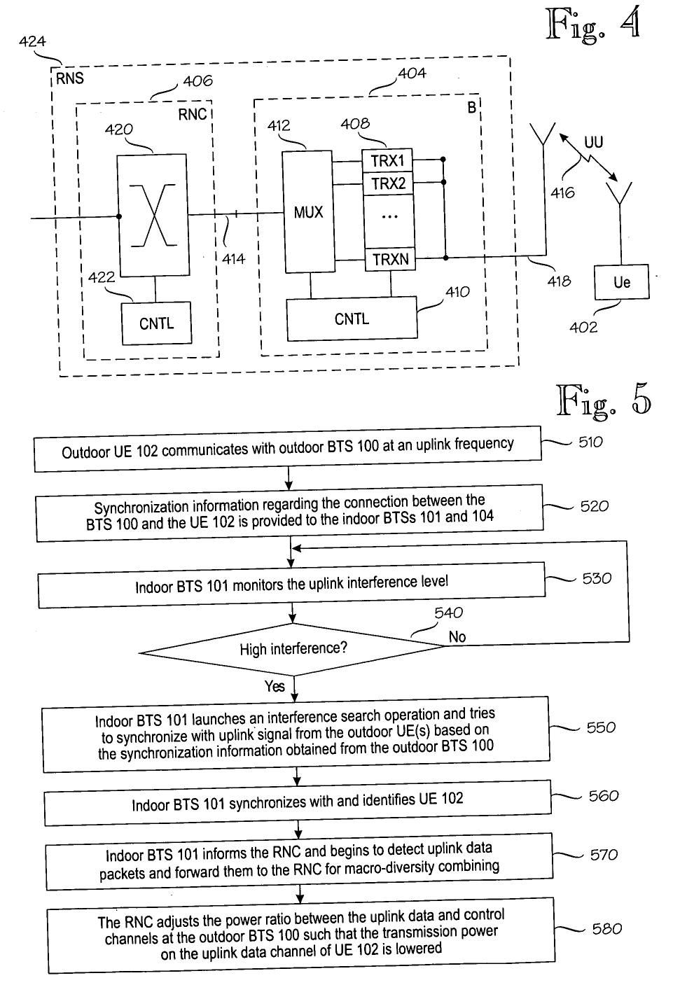

Referring to FIGS. 1 and 2, let us now consider the situation where an outside UE 102 transmits on an uplink transmission power level which causes an increased uplink interference level at the indoor base station BTS 101 (the interference 300 in FIG. 2), step 510 in FIG. 5. The UE 102 is, however, outside the downlink coverage area 201 of the indoor BTS 101 and cannot detect the common pilot channel of the indoor BTS 101. Thus, a soft handover to the indoor BTS 101, adding the indoor BTS 101 to an active set of the UE 102, and the power control of the UE 102 from the indoor BTS 101 are not possible.

According to an embodiment of the invention, an arrangement is provided that enables an uplink connection of the outdoor UE 102 of FIG. 1 with indoor BTS 101 in order to decrease the increased uplink interference caused by an uplink transmission of a potentially interfering outdoor UE 102 which is connected to the outdoor BTS 100 but which is outside the downlink coverage area 201 of the indoor BTS 101. This can be performed in quite a similar manner as in a soft handover specified for the specific cellular network, but only in the uplink direction. No downlink connection is provided between the UE 102 and the indoor BTS 101.

To this end, the indoor BTS 101 is actively following the interference load in the indoor cell 201, step 530 in FIG. 5. In the present WCDMA system, this is done by means of load control but any other appropriate interference estimation methods may also be used. Monitoring may also be performed at an appropriate controlling entity in the cellular communication network, such as the RNC, based on information obtained from the indoor BTS 101. If the inter-cell interference in the uplink direction (such as the interference 300 in FIG. 2) exceeds a certain threshold (given in advance), then an interference search procedure is launched at the indoor BTS 101 for searching the potentially interfering UE or UEs, steps 540 and 550 in FIG. 5.

For the interference search operation, the indoor BTS 101 is provided with the information needed for synchronization with the outdoor UE(s), step 520 in FIG. 5. In an embodiment of the invention, all base stations in a predetermined area (such as BTSs 100, 101 and 104 in FIG. 1) share the information that enables the uplink synchronization of any UE with any BTS provided that the received power level from the UE is high enough. For each user or UE, the synchronization information may contain the scrambling code, the channelization code(s), the pilot patterns and/or the timing. In an embodiment of the invention, information sharing is done via an appropriate controlling entity in the cellular communication network, such as the RNC, which may slightly increase the signaling load at the lub interface. In a further embodiment, the base stations exchange the synchronization information directly with each other.

In an embodiment of the invention, in order to avoid a heavy synchronization process, the location of each individual BTS is preferably stored in an appropriate controlling entity in the cellular communication network, such as the RNC, or in all BTS's in the area. Then, if the timing of the signal with respect to the outdoor BTS 100 is known, a good initial value for the timing with respect to the indoor BTS 101 can be computed. The initial timing for the indoor BTS 101 can be obtained from the timing of the outdoor BTS 100 by correcting it with the time corresponding to the distance between the outdoor and indoor BTSs, assuming that the coverage 201 of the indoor BTS 101 is small.

When the interference search is launched, the indoor BTS 101 tries to synchronize with the interfering UE 102 by applying the provided user information, step 550 in FIG. 5. If the indoor BTS 101 is able to synchronize with the uplink signal 300 from the outdoor UE, and the interfering UE 102 is successfully identified (step 560 in FIG. 5), the indoor BTS 101 sends an acknowledgement to an appropriate controlling entity in the cellular communication network, such as the RNC, and the outdoor BTS 100, and the detection of the uplink signal begins, step 570 in FIG. 5. Data blocks or packets are sent to the RNC for macro-diversity combining. In an embodiment of the invention, the macro-diversity combining is performed in one of the base stations, such as the outdoor BTS 100.

The macro-diversity combining may be performed in a similar manner as in a conventional soft handover in the WCDMA. Since the signal power level in the uplink between the outdoor UE 102 and the indoor BTS 101 is high (otherwise the outdoor UE 102 is not a dominant interferer to the indoor BTS 101), the macro-diversity combining gain will improve the data detection of the uplink data transmission. It should be noted that in the present FDD WCDMA as specified, the macro-diversity combining is actually a selection between data blocks received through different paths, in this example via the base stations BTS 100 and 101.

Thus, while the number of frame errors in the uplink signal from the outdoor UE 102 decreases due to the macro-diversity gain, the outdoor BTS 100 may lower the UE transmission power on the uplink data channel without compromising the quality of the data transmission, step 580 in FIG. 5. However, if the UE transmission power of the uplink control channel is also adjusted, then the RNC may reduce the SIR target at the outdoor BTS 100, which further leads to reduced QoS (Quality of Service) in the control channel. In an embodiment of the invention, the lowering of UE transmission power on the uplink data channel is implemented by means of calculating and changing (e.g. in the RNC) the power ratio between data and control channels according to the improved QoS on the uplink data channel. This can be done according to the present WCDMA specifications, for example (see TS 25.213, v.5.5.0, p. 9). Adjustment of the power difference between the uplink control and data channels may be based for instance on the measured SIR at the indoor BTS. In this way, the transmission power on the control channel remains unchanged. Although the “interference level” on the control channel does not now change, the data channel is the main interference source from the indoor BTS 101 point of view, and the overall interference is thereby significantly reduced. The higher the data rate on the data channel, the higher can be the power difference between the data and control channels.

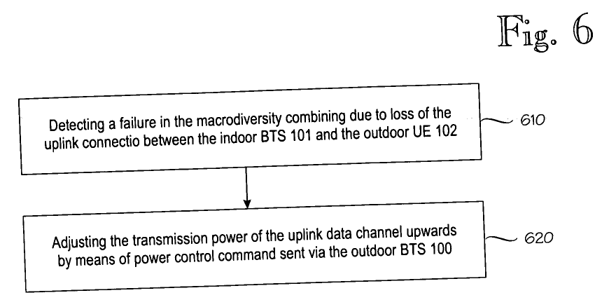

If the outdoor UE suddenly moves to a position where the path loss to the indoor base station 101 increases considerably (several dBs) and the indoor base station 101 cannot receive the uplink signal any more, the macro-diversity gain is lost. Therefore, in an embodiment of the invention, when detecting a macro-diversity failure (step 610 in FIG. 6), the entity performing the macro-diversity combining causes, via the downlink link of the outdoor BTS 100, the outdoor UE 102 to adjust the transmission power of the uplink data channel upwards, for instance to the level used according to a conventional power control algorithm (to the original level), step 620 in FIG. 6. As a result, the uplink data transmission is not interrupted.

Re-transmission may be used in a wireless cellular network to compensate a failure occurring in the reception of a data packet, a data block, or a data frame. The retransmission takes place when the receiving transceiver of packets requests the faulty packet to be repeated. This can be performed by an ARQ (Automatic Repeat Request) mechanism. In a receiver utilizing HARQ (Hybrid ARQ), the faulty packet and the retransmitted packet can be combined. In the “soft handover” according to the invention, the downlink acknowledgements ACK and negative acknowledgements and the like, are naturally sent only via the outdoor BTS 100. In an embodiment of the invention, the macro-diversity entity, such as the RNC, causes the adjustment of the data channel transmission power upwards in the case of the retransmission of a frame. The transmission power may be increased by a predetermined amount (X dBs) for each retransmitted frame or according to some other appropriate method based on the number of retransmissions, number of frame errors, bit error rate, etc. In an embodiment of the invention, the original power level (e.g. the transmission power ratio between the uplink control and data channels) is applied immediately after detecting a frame error. These embodiments of the invention offer faster reaction to the sudden changes in the radio link between the outdoor UE 102 and the indoor BTS 101 than the conventional power control. Since the signal power level in the uplink between the outdoor UE 102 and the indoor BTS 101 is low, the outdoor UE 102 is no longer a dominant interferer to the indoor BTS 101. If the interference situation reappears, the procedure according to the invention is restarted.

By the merits of the above-explained arrangement, the interference 300 of FIG. 2 can be reduced and, at the same time, the capacity of the outdoor BTS 100 increased since intra-cell interference decreases while the transmission power of outdoor UE 102 decreases.

Even though the invention is described above with reference to examples according to the accompanying drawings, it is obvious to a person skilled in the art that the invention is not restricted thereto but can be modified or implemented in several other ways without departing from the spirit and scope of the appended claims.

1. A wireless cellular communication network, comprising:
at least one first base station having a relatively high downlink control-channel transmission power providing a first downlink coverage area;
at least one second base station having a relatively low downlink control-channel transmission power providing a second downlink coverage area, said at least one first base station and at least one second base station operating at a common uplink carrier frequency;
at least one user equipment;
means for monitoring an uplink inter-cell interference level on said at least one second base station;
means for synchronizing the at least one second base station with an uplink transmission signal received from at least one potentially interfering user equipment which is connected to said at least one first base station but outside said second downlink coverage area of said at least one second base station, in response to the uplink inter-cell interference level on said at least one second base station reaching a predetermined threshold level; and
means for controlling, via a downlink control channel of said at least one first base station, said at least one potentially interfering user equipment to lower a transmission power of the uplink transmission signal, and thereby decrease the uplink inter-cell interference level on said at least one second base station.

2. The network as claimed in claim 1, wherein said means for controlling includes means for adjusting a ratio between the transmission power of a dedicated uplink control channel and the transmission power of a dedicated uplink data channel of said at least one potentially interfering user equipment.

3. The network as claimed in claim 1, wherein the controlling means is configured to control the transmission power of the synchronized uplink transmission signal based at least partially on the uplink inter-cell interference level measured in said at least one second base station.

4. The network as claimed in claim 1, wherein said synchronizing means comprises means for providing said at least one second base station with synchronization information used for said at least one potentially interfering user equipment at said at least one first base station.

5. The network as claimed in claim 1, comprising means for macro-diversity combining uplink data received via said at least one first base station and at least one second base station from said at least one user equipment.

6. The network as claimed in claim 1, wherein said at least one first base station comprises an outdoor base station and said at least one second base station comprises an indoor base station.

7. A small-coverage base station for a wireless cellular communication network, said small-coverage base station having a downlink coverage area which is substantially smaller than a downlink coverage area of a neighboring large-coverage base station, said small-coverage base station comprising:
means for monitoring an uplink inter-cell interference level on said small-coverage base station;
means for synchronizing the small-coverage base station to an uplink transmission signal received from at least one potentially interfering user equipment which is outside said downlink coverage area of said small-coverage base station but connected to said large-coverage base station, in response to the uplink inter-cell interference level on said small-coverage base station reaching a predetermined threshold level; and
means for providing to said large-coverage base station or to a network controller a power control command or information causing said at least one potentially interfering user equipment to be controlled via a downlink control channel of said large-coverage base station to lower a transmission power of an uplink transmission signal, and thereby decrease the uplink inter-cell interference level on said small-coverage base station.

8. The base station as claimed in claim 7, wherein said synchronizing means comprises means for obtaining, from said large-coverage base station or the network controller, synchronization information used for said at least one potentially interfering user equipment at said large-coverage base station.

9. The base station as claimed in claim 7, comprising means for forwarding uplink data to the network controller or said large-coverage base station for a macro-diversity combining.

10. The base station as claimed in claim 7, wherein said power control command or information includes the uplink inter-cell interference level estimated at said small-coverage base station.

11. The base station as claimed in claim 7, wherein said large-coverage base station comprises an outdoor base station and said small-coverage base station comprises an indoor base station.

12. A controlling network element for a wireless cellular communication network including at least one user equipment, at least one large-coverage base station and at least one small-coverage base station having a downlink coverage area which is substantially smaller than the downlink coverage area of said at least one large-coverage base station, said at least one small-coverage and large-coverage base stations operating at a common uplink carrier frequency, said network controlling element being configured to control, via a downlink control channel of said macro base station, at least one interfering user equipment to lower a transmission power of an uplink transmission signal, and thereby decrease an uplink inter-cell interference level on said at least one small-coverage base station, to the uplink inter-cell interference level on said at least one small-coverage base station reaching a predetermined threshold level and said at least one small-coverage base station to the uplink transmission signal received from at least one potentially interfering user equipment which is connected to said at least one large-coverage base station but outside said downlink coverage area of said at least one small-coverage base station.

13. The controlling network element as claimed in claim 12, said controlling network element being configured to adjust a ratio between the transmission power of a dedicated uplink control channel and the transmission power of a dedicated uplink data channel of said at least one interfering user equipment.

14. The controlling network element as claimed in claim 12, the controlling network element being configured to control the transmission power of a synchronized uplink transmission signal based at least partially on the uplink inter-cell interference level measured in said at least one small-coverage base station.

15. The controlling network element as claimed in claim 12, comprising means for macro-diversity combining uplink data received via said at least one small-coverage and said at least one large-coverage base stations from said at least one user equipment.

16. The controlling network element as claimed in claim 12, said controlling network element being configured to command, via the downlink control channel of said macro base station, said at least one interfering user equipment to adjust the transmission power of the uplink transmission signal upwards, when said controlling network element detects a predetermined event, error or failure in at least one of the macro diversity combining, retransmission, and data reception.

17. The controlling network element as claimed in claim 16, wherein said predetermined event, error or failure includes one of a retransmission of a frame, a number of retransmissions, a frame error, a number of frame errors, and a bit error rate.

18. The controlling network element as claimed in claim 16, wherein said command to adjust is a command to restore an initial uplink transmission power or an initial ratio between the transmission power of a dedicated uplink control channel and the transmission power of a dedicated uplink data channel of said at least one interfering user equipment.

19. The controlling network element as claimed in claim 16, wherein said command to adjust is a command to increase the uplink transmission power or the ratio between the transmission power of a dedicated uplink control channel and the transmission power of a dedicated uplink data channel of said at least one interfering user equipment by a predetermined step.

20. The controlling network element as claimed in claim 12, said controlling network element comprising a radio network controller.

21. The controlling network element as claimed in claim 12, said controlling network element being integrated into at least one of the base stations in said wireless cellular communication network.

22. The controlling network element as claimed in claim 12, said controlling network element being configured to provide said at least one small-coverage base station with synchronization information used for said at least one interfering user equipment at said at least one large-coverage base station.

23. The controlling network element as claimed in claim 12, wherein said at least one large-coverage base station comprises an outdoor base station and said at least one small-coverage base station comprises an indoor base station.
